(19) United States
(12) Patent Application Publication
(10) Pub. No.: US 2013/0170903 A1
(43) Pub. Date: Jul. 4, 2013

(54) SHRINK DISC

(71) Applicants: Thomas Moka, Rudermark (DE); Manfred Niessen, Grossostheim (DE); Rainer Peter, Reinheim-Spachbrucken (DE)

(72) Inventors: Thomas Moka, Rudermark (DE); Manfred Niessen, Grossostheim (DE); Rainer Peter, Reinheim-Spachbrucken (DE)

(73) Assignee: RINGFEDER POWER TRANSMISSION GMBH, Gross-Umstadt (DE)

(21) Appl. No.: 13/821,803

(22) PCT Filed: Aug. 31, 2011
(86) PCT No.: PCT/EP2011/064980

§ 371 Date: Mar. 8, 2013

(30) Foreign Application Priority Data
Sep. 17, 2010 (DE) 10 2010 037 611.6

(51) Int. Cl. F16D 1/095

(52) U.S. Cl. CPC F16D 1/095
USPC 403/374.4; 403/374.1

(57) ABSTRACT

A shrink disc is provided for the force-fit respectively friction-fit interconnecting of a shaft and a hollow shaft or the like having an interior compression ring (2), the outer circumferential surface of which has at least one conical surface (4), and at least one outer pressure ring (3) which in turn has at least one radially outward winding (10) consisting of a band and the inner circumferential surface of which comprises a conical surface (5) cooperating with the conical surface (4) of the compression ring (2) so that the compression ring (2) is compressed when axially tensioned. To manufacture the winding (10), the band is wrapped around the pressure ring (3) under tensile stress. This thus achieves being able to subject the shrink disc to higher loads.

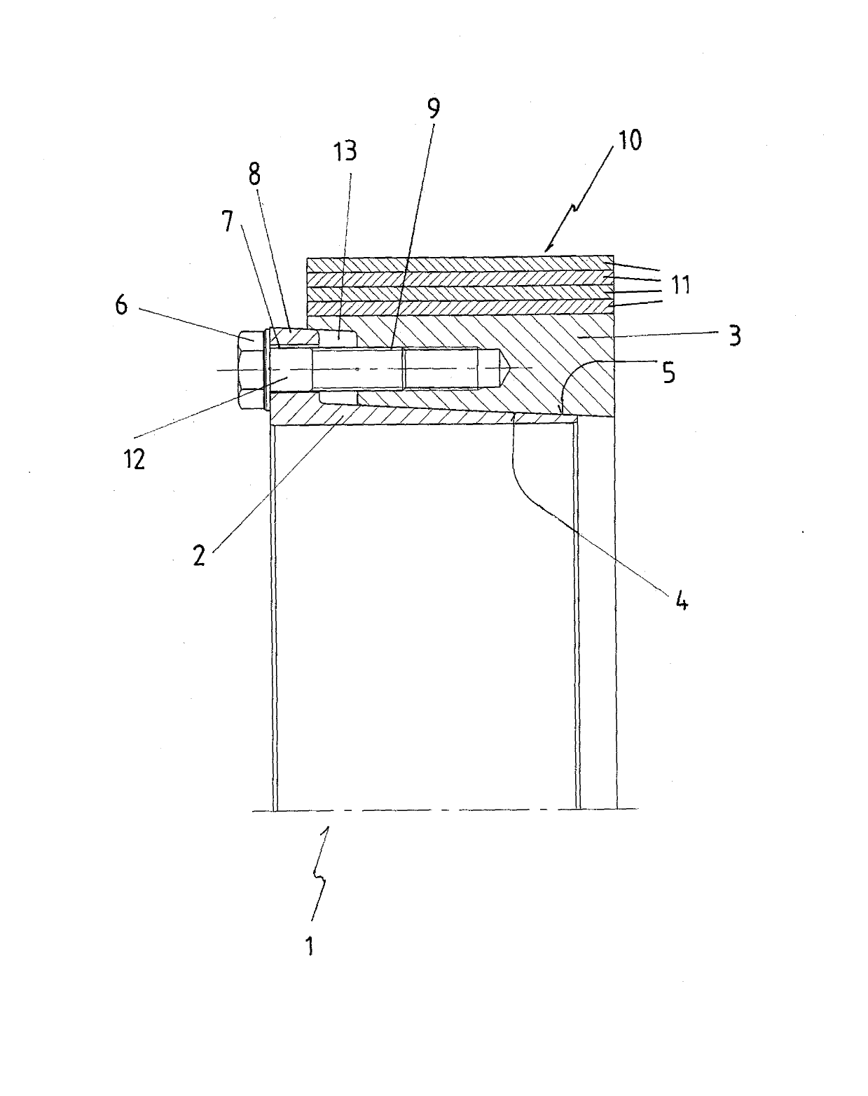

The invention relates to a shrink disc for the force-fit respectively friction-fit interconnecting of a shaft and a hollow shaft or the like having an interior compression ring, the outer circumferential surface of which comprises at least one conical surface, and at least one outer pressure ring which in turn has at least one radially outward winding consisting of a band and the inner circumferential surface of which comprises a conical surface cooperating with the conical surface of the compression ring so that the compression ring is compressed when axially tensioned.

Clamping assemblies respectively shrink discs have at least one pair of conical active surfaces and have been known for a long time. They serve for interconnecting a shaft and a hollow shaft or a shaft and a cylindrical hub extension surrounding same, etc.

A conventional clamping assembly for fixing a hub to a shaft is known, for instance from DE2601138. Said clamping assembly has a cylindrical opening for inserting a cylindrical shaft or the like and a conical outer circumferential surface which is coaxial to the cylinder axis. Said known clamping assembly is moreover provided with a pressure ring, the opening of which forms a corresponding inner circumferential surface intended for being axially pressed onto the conical outer circumferential surface of the compression ring. In addition, the pressure ring is divided into a radially outer ring and an inner ring.

From DE19828628C5, a clamping assembly, respectively shrink disc, is known in which the radially outward pressure ring has an outer ring supported radially outwardly without any opposing face which represents inter alia a winding of a steel band, respectively spring band steel. Further relevant publications are mentioned in this publication which explain the further prior art and to which reference is made.

Taking this prior art as a basis, a task of the present invention is to provide a shrink disc which can be exposed to higher loads.

This task is solved by the teaching of the claims.

In the shrink disc according to the invention, the winding is thus formed by a band being wrapped around the outer pressure ring under tensile stress.

The term “band” stands in this case for all possible bands which can be used for such purposes. Preferably, it is a band or a sheet of steel or spring band steel or a band of carbon fiber. Further preferred, the band, respectively steel band, has a thickness of 0.05 to 2.5 mm, and in particular 0.51 mm. This range of 0.05 to 2.5 mm comprises all the values falling into this range, and in particular, for example, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4 and 2.5 mm and all narrower ranges.

The tensile stress when winding the outer pressure ring can have any arbitrary value and is preferably 50-450 N/mm² as well as particularly preferred about 200 N/mm².

With the range of tensile stress of 50-450 N/mm², all of the individual values comprised by this range are disclosed, e.g. 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450. Narrower ranges are also disclosed by the indicated range.

The number of the outer pressure ring's winding layers can be selected as needed and may be several hundreds of layers. This number of course also depends on the shrink disc dimensions and the thickness of the band employed. The winding of the shrink disc according to the invention preferably has 2 to 400 layers, and particularly preferred 140 to 160 layers. This range of 2 to 400 layers comprises all of the integer values falling into this range, and in particular, for example, 2, 3, 4, 5, 6, 25, 26, 27, 29, 58, 59, 60, 61, 125, 126, 127, 140, 141, 142, 143, 144, 145, 146, 147, 148, 149, 150, 151, 152, 153, 154, 155, 156, 157, 158, 159, 160, 186, 187, 188, 247, 248, 249, 333, 334, 335, 397, 398, 399 and 400.

The pressure ring and compression ring may be made of any suitable material. Both rings are preferably made of steel.

The axial tensioning of the compression ring and pressure ring is preferably effected by means of axially directed screws or hydraulically. Preferably, the screws are in particular arranged evenly distributed over a circumference. If threaded press-off bores are present, same must be taken into account so that said pitch will then not be uniform.

Due to wrapping the pressure ring with a spring band steel while exerting tensile stress, a compressive stress directed radially inward is introduced into the wound outer ring.

When tensioning the shrink disc on a shaft or the like, a tensile stress directed radially outward is generated on the compression ring. This tensile stress is transmitted to the outer ring. Since this outer ring, however, is biased radially inward, this compressive stress directed radially inward must first be “overcome” or “compensated” before the outer pressure ring as such has to absorb radially directed tensile stress.

The winding thus essentially relieves the outer ring. Distinctly cheaper materials can thus be used for the outer ring. For example, instead of 50 Cr V4 steel having a yield strength of about 850 N/mm², C60 steel having a yield strength of 600 N/mm² can now be used for the outer pressure ring.

Incidentally, cold-rolled tempered spring steel bands having tensile strengths of 2600 N/mm² and yield strengths of about 2400 N/mm² are already available which can be used according to the invention. When such spring bands are used along with simultaneously applying an increased tension during winding, even “simple steels” such as C22 or St52 can be used for the pressure ring.

For the remainder, the invention is not limited to shrink discs having only one winding or one pressure ring. Rather, shrink discs exhibiting two pressure rings, for example with each pressure ring having a respective winding, are also comprised according to the invention. The constructional configuration of such a shrink disc, respectively such a clamping assembly, is already known from DE19828628C5 mentioned at the beginning to which reference is herewith made.

The invention will be described below on the basis of a shrink disc having only one outer pressure ring and only one winding.

The accompanying single drawing depicts a longitudinal section through the upper half of a shrink disc according to the invention in a non-tensioned state.

As can be seen from the cross-section shown in the drawing, a shrink disc according to the invention has a compression ring 2 and a thereto coaxial pressure ring 3.

The compression ring 2 is set atop a shaft or hollow shaft (not shown) and has a cylindrical inner circumferential surface. The compression ring 2 has no slot in the shown example. However, compression rings having such a slot can also be employed. The outer circumferential surface of the compression ring 2 has a conical surface 4 cooperating with a conical surface 5 on the inner circumferential surface of the pressure ring 3.

When the compression ring 2 is displaced in the axial direction into the pressure ring 3, then the opposing conical surfaces 4, 5 will slide onto each other and clamp the not shown hollow shaft with the shrink disc 1.

A plurality of threaded screws 12 serve this clamping, same being equipped with a head 6 and extending through a bore 7 into a flange 8 and protruding into a corresponding threaded bore 9 in the outer pressure ring 3. The flange 8 is arranged at an axial end of the compression ring 2 (left-hand side in the drawing) and extends radially outward about the compression ring 2. The bores 7 for the screws 12 are in this case arranged evenly distributed over the circumference. During said clamping, the flange 8 is displaced into a circumferential annular extension 13 of pressure ring 3.

The pressure ring 3 is provided with a radially outward winding 10 composed in total of 150 layers 11. For reasons of better graphic representation, however, only 4 layers 11 are shown in the drawing.

For manufacturing said winding 10, the outer pressure ring 3 is wrapped 150 times with a spring band steel. During the winding, the desired tensile stress is exerted upon the spring band steel.

The shrink disc according to the invention can have any desired size.

For example, when an outer pressure ring 3 having an outer diameter of 680 mm is used and same is wrapped about 150 times with a spring band steel having a thickness of about 0.51 mm while applying a tensile stress of 200 N/mm² up to an outer diameter of 850 mm, then a force of about 2550 kN builds up per side. The inner diameter of pressure ring 3 in this case was about 551 mm (average taper diameter). In a pressure ring 3 wound in this manner, a compressive stress directed radially inward of about 260 N/mm² was realized in the interior of the pressure ring 3.

When the shrink disc 1 is now slipped onto a hollow shaft or a shaft and clamped in the described manner, this compressive stress directed radially inward then first needs to be compensated before the pressure ring 3 as such has to absorb and compensate pressures directed radially outwardly.

### REFERENCE NUMERALS

1 shrink disc
2 compression ring
3 outer pressure ring
4 conical surface of compression ring
5 conical surface of pressure ring
6 head
7 bore
8 flange
9 threaded bore
10 winding
11 layer
12 threaded screw
13 annular extension

1-10. (canceled)

11. A shrink disc for a force or friction-fit interconnection between a shaft and a hollow shaft comprising:
an interior compression ring having an outer circumferential surface, said outer circumferential surface comprising at least one conical surface;
at least one outer pressure ring having an outer circumference, and an inner circumferential surface comprising a conical surface configured to cooperate with the at least one conical surface of the compression ring so that the compression ring is compressed when the outer pressure ring is axially moved against the compression ring;
a band winding under tensile stress wound at least once around the outer circumference of the outer pressure ring.

12. The shrink disc according to claim 11, wherein the band is made of steel or carbon fiber.

13. The shrink disc according to claim 12, wherein the band is made of a sheet of steel or spring band steel.

14. The shrink disc according to claim 13, wherein the band of steel or spring band steel has a thickness of 0.05 to 2.5 mm.

15. The shrink disc according to claim 11, wherein the tensile stress is 50 to 450 N/mm².

16. The shrink disc according to claim 11, wherein the winding comprises 2 to 400 layers.

17. The shrink disc according to claim 11, wherein the compression ring and the pressure ring are made of steel.

18. The shrink disc according to claim 11, including screws or a hydraulic device to effect axial tensioning.

19. The shrink disc according to claim 18, wherein the screws are arranged evenly distributed over the circumference of the shrink disc.

20. The shrink disc according to any one of claims 11-19, wherein the at least one conical surface of the interior compression ring comprises a pair of oppositely directed conical surfaces and wherein said at least one outer pressure ring comprises two pressure rings having respective oppositely directed conical surfaces each cooperating with a respective conical surface of the interior compression ring; and wherein both pressure rings each include said band winding under tensile stress wound at least once around the outer circumference of the outer pressure ring.
